(19) United States
(12) Patent Application Publication
(10) Pub. No.: US 2024/0097725 A1
(43) Pub. Date: Mar. 21, 2024

(54) TRANSMIT REDUNDANCY AND AUTONOMOUS RECEIVER CHANNEL SELECTION IN A WIRELESS IN-EAR MONITOR AUDIO SYSTEM

(71) Applicant: Shure Acquisition Holdings, Inc., Niles, IL (US)

(72) Inventors: Thomas J. Kundmann, Oakland Hills, IL (US); Robert Mamola, Oak Park, IL (US); Steve Van Gheem, Gilberts, IL (US)

(21) Appl. No.: 18/467,575

(22) Filed: Sep. 14, 2023

Related U.S. Application Data
(60) Provisional application No. 63/375,999, filed on Sep. 16, 2022.

(51) Int. Cl. H04B 1/10; H04H 60/32; H04H 60/43; H04R 1/10

(52) U.S. Cl. CPC H04B 1/1027; H04H 60/32; H04H 60/43; H04R 1/1016; H04R 1/1041; H04B 2001/1072; H04R 2420/07

(57) ABSTRACT

Techniques for providing transmit redundancy for a wireless audio system, such as an in-ear monitor audio system, are discussed herein. Some embodiments may include tuning to a first wireless communication channel associated with a first carrier frequency to receive a radio frequency signal. Based on a determination that a communication channel condition for the first wireless communication channel satisfies a communication channel condition threshold, various embodiments include tuning to a second wireless communication channel associated with a second carrier frequency to receive the radio frequency signal, where the second carrier frequency is different from the first carrier frequency.

### CROSS REFERENCE TO RELATED APPLICATIONS

This application claims the benefit of U.S. Provisional Patent Application No. 63/375,999, titled “TRANSMIT REDUNDANCY AND AUTONOMOUS RECEIVER CHANNEL SELECTION IN A WIRELESS IN-EAR MONITOR AUDIO SYSTEM,” and filed on Sep. 16, 2022, the entirety of which is hereby incorporated by reference.

### TECHNICAL FIELD

Embodiments of the present disclosure relate generally to audio processing and, more particularly, to processing of radio frequency signals in a wireless audio system.

### BACKGROUND

A wireless audio transmitter of a wireless audio system may be configured to broadcast a radio frequency signal for one or more wireless audio receivers. However, interference is often present in a radio frequency environment for a wireless audio system.

### BRIEF SUMMARY

Various embodiments of the present disclosure are directed to improved apparatuses, systems, methods, and computer readable media for providing interference avoidance in a wireless audio system such as, for example, an in-ear monitor audio system. These characteristics as well as additional features, functions, and details of various embodiments are described below. The claims set forth herein further serve as a summary of this disclosure.

### BRIEF DESCRIPTION OF THE DRAWINGS

Having thus described some embodiments in general terms, reference will now be made to the accompanying drawings, which are not necessarily drawn to scale, and wherein:

FIG. 1 illustrates an example wireless audio system that comprises a wireless audio transmitter and one or more wireless audio receivers in accordance with one or more embodiments disclosed herein;

FIG. 2 illustrates an exemplary wireless audio receiver apparatus configured in accordance with one or more embodiments disclosed herein;

FIG. 3 illustrates an example wireless audio transmitter system that comprises a wireless audio transmitter in accordance with one or more embodiments disclosed herein;

FIG. 4A illustrates an example wireless audio receiver system that comprises a wireless audio receiver in accordance with one or more embodiments disclosed herein;

FIG. 4B illustrates another example wireless audio receiver system that comprises a wireless audio receiver in accordance with one or more embodiments disclosed herein;

FIG. 5 illustrates an example wireless audio receiver system that comprises a wireless audio receiver and a listening device in accordance with one or more embodiments disclosed herein;

FIG. 6 illustrates an example method for mitigating interference related to a radio frequency signal received by a wireless audio receiver in accordance with one or more embodiments disclosed herein; and

FIG. 7 illustrates an example method for mitigating interference related to radio frequency signals transmitted by a wireless audio transmitter in accordance with one or more embodiments disclosed herein.

### DETAILED DESCRIPTION

Various embodiments of the present disclosure will now be described more fully hereinafter with reference to the accompanying drawings, in which some, but not all embodiments of the present disclosure are shown. Indeed, the disclosure may be embodied in many different forms and should not be construed as limited to the embodiments set forth herein. Rather, these embodiments are provided so that this disclosure will satisfy applicable legal requirements.

Overview

A wireless audio transmitter of a wireless audio system may be configured to broadcast a radio frequency signal for one or more wireless audio receivers. Traditionally, a one-to-one communication link is established between a wireless audio transmitter and one or more wireless audio receivers of a wireless audio system to transmit a radio frequency signal. However, interference or other signal audio degrading conditions may be present in a radio frequency environment for a wireless audio system. As such, it is desirable to reduce the effect of interference with respect to a wireless audio transmitter and/or one or more wireless audio receivers in a wireless audio system.

With traditional wireless audio systems, if a wireless audio receiver identifies interference with respect to a wireless communication channel, the wireless audio transmitter and the wireless audio receiver may simultaneously switch to a different wireless communication channel associated with a different carrier frequency. However, for certain types of wireless audio systems such as, for example, in-ear monitor (IEM) systems, there may be numerous wireless audio receivers tuned to a particular wireless communication channel. Furthermore, one or more of these wireless audio receivers may experience interference while one or more other wireless audio receivers may be physically located such that no interference is experienced. It is therefore undesirable to interrupt audio continuity of the one or more other wireless audio receivers associated with no interference by, for example, retuning a carrier frequency for the one or more other wireless audio receivers or by interrupting audio continuity in another manner. For example, it is often undesirable to simultaneously switch the wireless audio transmitter and the numerous wireless audio receivers to a different wireless communication channel associated with a different carrier frequency.

To address these and/or other technical problems associated with wireless audio systems, various embodiments disclosed herein provide interference avoidance using transmit redundancy for a wireless audio system. The wireless audio system may be an in-ear monitor audio system or another type of wireless audio system. With the transmit redundancy for the wireless audio system, a radio frequency signal may be transmitted via two or more carrier frequencies. For example, a wireless audio transmitter of the wireless audio system may transmit a radio frequency signal via two or more wireless communication channels respectively configured at unique carrier frequencies. The radio frequency signal may be an audio signal such as, for example, a stereo audio mix or a mono audio mix. As such, depending on conditions for a radio frequency environment for the wireless audio system, each wireless audio receiver in the wireless audio system may independently tune to an optimal carrier frequency (e.g., an optimal wireless communication channel) to receive the radio frequency signal transmitted by the wireless audio transmitter. To facilitate the transmit redundancy, a wireless audio receiver may be configured as a wide-tuning receiver capable of being tuned to two or more wireless communication channels.

By providing transmit redundancy for the wireless audio system, interference avoidance for one or more wireless audio receivers may be provided. Respective wireless audio receivers may therefore mitigate interference without unduly perturbing other wireless audio receivers in the wireless audio system. Additionally, low-impact interference mitigation for one-to-many broadcast applications such as, for example, IEM systems, may therefore be provided. It is to be appreciated that the transmit redundancy may additionally or alternatively be provided to mitigate one or more other types of wireless audio system conditions besides interference. For example, each wireless audio receiver in the wireless audio system may independently tune to an optimal wireless communication channel based on one or more signal degradation conditions associated with a wireless communication channel. In some examples, a wireless audio receiver may independently tune to an optimal wireless communication channel based on informed decisions related to a respective communication channel condition for the optimal wireless communication channel and one or more other wireless communication channels. Accordingly, performance for one or more wireless audio receivers in the wireless audio may be improved by providing transmit redundancy for the wireless audio system.

### Exemplary Wireless Audio Systems and Methods

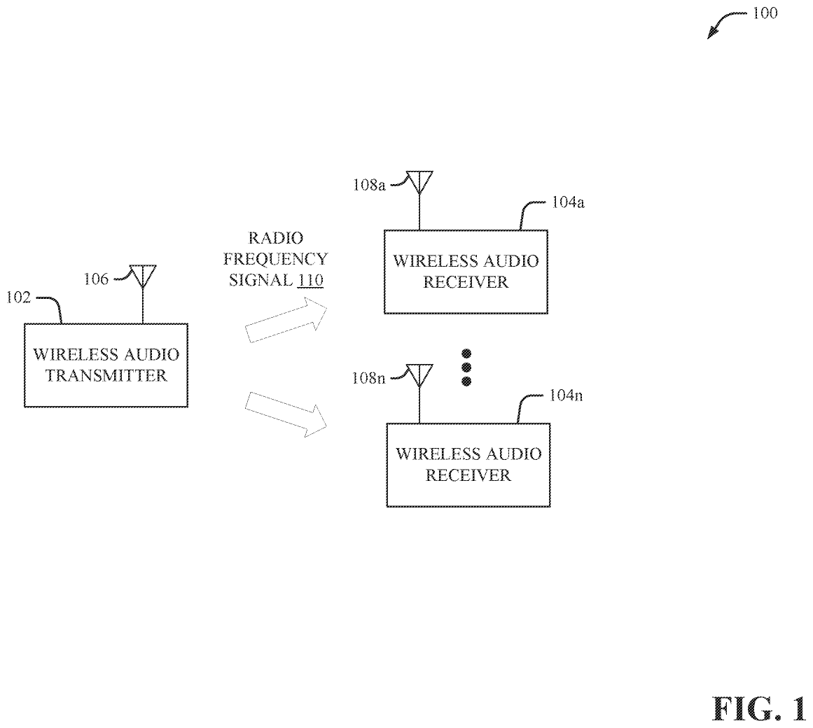

FIG. 1 illustrates a wireless audio system 100 that is configured to provide transmit redundancy according to one or more embodiments of the present disclosure. The wireless audio system 100 may be, for example, a personal monitor system, a personal stereo monitor (PSM) system, an IEM system, an audio performance system, a music performance system, an audio production system, a music recording system, a conference audio system, or another type of audio system. In some examples, the wireless audio system 100 is a wireless multi-channel audio system (WMAS). The wireless audio system 100 comprises a wireless audio transmitter 102 and one or more wireless audio receivers 104a-n. The wireless audio transmitter 102 may be a wireless access point, a wireless monitor transmitter, a wireless a rack-mountable transmitter, or another type of transmitter. The one or more wireless audio receivers 104a-n may be one or more portable receivers, one or more wireless monitor receivers, one or more in-ear control receivers, one or more bodypack receivers, one or more conference unit receivers, and/or one or more other types of receivers.

The wireless audio transmitter 102 may be configured to transmit a radio frequency signal 110 via two or more wireless communication channels. For example, the wireless audio transmitter 102 may simultaneously transmit the radio frequency signal 110 at two or more carrier frequencies via an antenna 106 of the wireless audio transmitter 102. Accordingly, the wireless audio transmitter 102 may transmit the radio frequency signal 110 via a wireless communication channel associated with a first carrier frequency, and the wireless audio transmitter 102 may also redundantly transmit the radio frequency signal 110 via one or more other wireless communication channels respectively associated with different carrier frequencies. The radio frequency signal 110 may be an audio signal such as, for example, a stereo mix audio signal or a mono mix audio signal configured for a particular radio frequency for wireless electromagnetic communication. Additionally, the radio frequency signal 110 may be transmitted at a particular carrier frequency according to a particular wireless communication channel. In some examples, the radio frequency signal 110 may be modulated according to a modulation scheme for a WMAS.

In some examples, the radio frequency signal 110 includes an audio payload. The audio payload may represent an audio waveform of an analog audio signal or a digital audio signal. The audio payload may be audio data that is modulated via the radio frequency signal 110 according to a particular frequency, amplitude, bandwidth, and/or modulation scheme associated with a wireless communication channel. In some examples, the audio payload may be configured as encoded information within a sideband portion of the radio frequency signal 110. In some examples, the radio frequency signal 110 transmitted via at least a first wireless communication channel and a second wireless communication channel may include a corresponding audio payload.

In some examples, the radio frequency signal 110 additionally includes control information. The control information may be utilized by the one or more wireless audio receivers 104a-n to manage access to the radio frequency signal 110 via a particular wireless communication channel. In some examples, the control information includes information such as, but not limited to: a wireless communication channel identifier, a modulation scheme identifier, control symbols, error detection codes, synchronization information, handshake information, channel access information, power control information, volume control information, gain control information, equalization information, carrier frequency information, and/or other control information for a particular wireless communication channel associated with the radio frequency signal 110. In some examples, the control information may be configured as encoded information within a sideband portion of the radio frequency signal 110.

In some examples, the radio frequency signal 110 transmitted via at least a first wireless communication channel and a second wireless communication channel may include control information based on the respective first and second wireless communication channel. For instance, the radio frequency signal 110 transmitted via a first wireless communication channel may include control information associated with the first wireless communication channel. Additionally, the radio frequency signal 110 transmitted via a second wireless communication channel may include control information associated with the second wireless communication channel.

Additionally, in an example, the radio frequency signal 110 may include data symbols in resource elements of resource blocks for respective subcarriers associated with at least audio data for a stereo audio mix or a mono audio mix for respective audio devices allocated to one or more audio channels mapped to the respective subcarriers. Data symbols, such as beacon symbols, modulation symbols, or the like, may define subframes of a radio frame. A resource element may be defined as one fast Fourier transform or discrete Fourier transform sample of a frequency dimension of the radio frequency signal 110, by one subframe of a tie dimension of the radio frequency signal 110. Subcarriers mapped to an audio channel may be part of a resource block and communicated by way of a radio frame structure comprising orthogonal subcarriers. Subcarriers allocated to audio channels for different audio devices may be grouped into a single radio frame. One or more guard subcarriers may be left empty between adjacent radio frames in the frequency dimension. In another example, the radio frequency signal 110 may be configured as a modulated signal associated with frequency modulation, linear narrowband modulation, non-linear narrowband modulation, or another type of modulation technique. However, it is to be appreciated that, in certain examples, the radio frequency signal 110 may be configured in a different manner to facilitate data transmission.

The wireless audio transmitter 102 may be configured for bi-directional audio, including uplink direction audio data and downlink direction audio data. Uplink and downlink direction audio data may be transmitted in different subcarriers or within one or more same subcarriers. When uplink and downlink audio data are transmitted by way of one or more same subcarriers, one or more resource elements of the one or more same subcarriers may be left empty between uplink direction resource elements and downlink direction resource elements in order to facilitate hardware changes, often referred to as turnaround time. The one or more empty resource elements in the one or more same subcarriers may be referred to as a guard period within a same radio frame. A guard period may additionally or alternatively be provided between different radio frames scheduled across a period of a time dimension of the radio frequency signal 110.

The antenna 106 may be configured as one or more antennas to facilitate simultaneous transmission of the radio frequency signal 110 via the two or more wireless communication channels. By providing transmit redundancy for the radio frequency signal 110, interference and/or another type of undesirable condition related to the radio frequency signal 110 may be mitigated. Though FIG. 1 depicts the antenna 106 as a single illustration, it is to be appreciated that the antenna 106 may be configured with two or more antennas (not shown) to enable efficient transmission of the radio frequency signal 110. For example, the antenna 106 may be configured in certain examples for transmit antenna diversity (e.g., transmit spatial diversity) via two or more transmit antennas.

The one or more wireless audio receivers 104a-n may be configured to respectively receive the radio frequency signal 110 via respective antennas 108a-n of the one or more wireless audio receivers 104a-n. The one or more wireless audio receivers 104a-n may be respectively configured as wide-tuning wireless audio receivers capable of being tuned to two or more wireless communication channels. For example, the respective antennas 108a-n may be configured for wide-band tuning such that tuning of the respective antennas 108a-n may be dynamically altered and tuned to a wireless communication channel.

FIG. 1 depicts each of antennas 108a-n as a single antenna for ease of illustration. However, each of the one or more wireless receivers 104a-n may be configured with two or more antennas (not shown) to enable efficient reception of the radio frequency signal 110. Said differently, the respective antennas 108a-n may each be configured for receive antenna diversity (e.g., receive spatial diversity) as two or more antennas are provided for each of the one or more wireless audio receivers 104a-n.

The one or more wireless audio receivers 104a-n are located at respective locations within a radio frequency environment for the wireless audio system 100. The one or more wireless audio receivers 104a-n may be configured as mobile wireless audio receivers such that the locations for the respective wireless audio receivers 104a-n may be dynamically altered within the radio frequency environment over time. In certain examples, the one or more wireless audio receivers 104a-n may be grouped based on a wireless audio receiver grouping operation performed by the wireless audio transmitter 102 and/or the one or more wireless audio receivers 104a-n to form a personal monitoring system for a stereo audio mix or a mono audio mix associated with the radio frequency signal 110.

Based on wireless audio system conditions for the wireless audio system 100, the one or more wireless audio receivers 104a-n are configured to independently tune to an optimal wireless communication channel associated with an optimal carrier frequency to receive the radio frequency signal 110 transmitted by the wireless audio transmitter 102. For example, based on conditions for the radio frequency environment for the wireless audio system 100, the one or more wireless audio receivers 104a-n may independently tune to an optimal wireless communication channel associated with an optimal carrier frequency (i.e., an improved or best carrier frequency selected from the redundantly transmitted carrier frequencies) to receive the radio frequency signal 110 transmitted by the wireless audio transmitter 102.

Tuning of the respective antennas 108a-n may be triggered based on the respective interference conditions local or proximate to the one or more wireless audio receivers 104a-n. An interference condition may be a condition for a radio frequency signal where an undesirable level of noise (e.g., a certain amount of undesirable radio frequency energy) is present on a wireless communication channel in addition to data (e.g., audio mix data) transmitted by the wireless audio transmitter 102. Alternatively, an interference condition may be a condition for a radio frequency signal where a certain amount of degradation is present to cause the radio frequency signal to have an undesirable signal-to-noise ratio.

When initially placed into an audio environment, the one or more wireless audio receivers 104a-n may independently tune to a first wireless communication channel associated with a first carrier frequency to receive the radio frequency signal 110. However, at least one of the one or more of the wireless audio receivers 104a-n may detect an interference condition, or more broadly speaking, may detect a communication channel condition that indicates undesirable audio quality for the radio frequency signal 110 transmitted on the first wireless communication channel. The at least one wireless audio receiver is then configured to determine if the detected communication channel condition for the first wireless communication channel satisfies a communication channel condition threshold and, if so, the respective wireless audio receiver is configured, independently from the other wireless audio receivers 104a-n that are not experiencing sufficient communication channel conditions, to tune to a second wireless communication channel associated with a second carrier frequency different from the first carrier frequency to receive the radio frequency signal 110.

In a non-limiting example, the wireless audio transmitter 102 transmits the radio frequency signal 110 via both a first wireless communication channel associated with a first carrier frequency and a second wireless communication channel associated with a second carrier frequency. Additionally, both the wireless audio receiver 104a and the wireless audio receiver 104n tune to the first wireless communication channel to receive the radio frequency signal 110. However, in response to detection of a communication channel condition that indicates undesirable audio quality via the first wireless communication channel for the wireless audio receiver 104a, the wireless audio receiver 104a may switch tuning of the wireless audio receiver 104a to the second wireless communication channel to receive the radio frequency signal 110 via the second wireless communication channel. Independent of the wireless audio receiver 104a and due to the redundant transmission of the radio frequency signal 110 by the wireless audio transmitter 102 via the first wireless communication channel and the second wireless communication channel, the wireless audio receiver 104n may maintain tuning of the wireless audio receiver 104n to the first wireless communication channel such that the wireless audio receiver 104a receives the radio frequency signal 110 via the second wireless communication channel simultaneous to the wireless audio receiver 104n receiving the radio frequency signal 110 via the first wireless communication channel. However, in response to detection of a communication channel condition that indicates undesirable audio quality via the first wireless communication channel for the wireless audio receiver 104n, the wireless audio receiver 104n may switch tuning of the wireless audio receiver 104n to the second wireless communication channel (or another wireless communication channel associated with the redundant transmission of the radio frequency signal 110 by the wireless audio transmitter 102) to receive the radio frequency signal 110.

In some examples, a wireless audio receiver such as the wireless audio receiver 104a utilizes informed decisions related to respective communication channel conditions for one or more candidate wireless communication channels to determine whether to switch tuning of the wireless audio receiver 104a to a different wireless communication channel to receive the radio frequency signal 110. To provide the informed decisions, a wireless audio receiver, such as the wireless audio receiver 104a, may analyze respective communication channel conditions for one or more candidate wireless communication channels for receiving the radio frequency signal 110. Additionally or alternatively, a wireless audio receiver such as the wireless audio receiver 104a may compare an active communication channel condition for a wireless communication channel that currently receives the radio frequency signal 110 to communication channel conditions for one or more candidate wireless communication channels for alternatively receiving the radio frequency signal 110. For example, in response to detection of a first communication channel condition for the first wireless communication channel that indicates undesirable audio quality via the first wireless communication channel for the wireless audio receiver 104a, the wireless audio receiver 104a may compare the first communication channel condition (i.e., the level of degradation on the first wireless communication channel) to a second communication channel condition (e.g., any relative degradation detected on the second wireless communication channel) for the second wireless communication channel.

In response to the second communication channel condition for the second wireless communication channel being deemed more favorable than the first communication channel condition for receiving the radio frequency signal 110, the wireless audio receiver 104a may switch tuning of the wireless audio receiver 104a to the second wireless communication channel to receive the radio frequency signal 110. However, in response to the second communication channel condition for the second wireless communication channel being deemed less favorable than the first communication channel condition for receiving the radio frequency signal 110, the wireless audio receiver 104a may not make the switch and may remain tuned to the first wireless communication channel. In another aspect, the wireless audio receiver 104a may attempt to repeat the above condition check process and determine the viability for retuning to a third wireless communication channel to receive the radio frequency signal 110. Accordingly, the informed decisions related to the respective communication channel conditions for the one or more candidate wireless communication channels may further mitigate interference and/or improve other undesirable communication channel conditions for receiving the radio frequency signal 110.

In some examples, a wireless audio receiver such as the wireless audio receiver 104a utilizes timing information of relevant wireless communication protocols used to carry out communications between the wireless audio transmitter 102 and the wireless audio receiver to provide the time needed to check communication channel conditions for alternate communication channels as part of the informed decision process discussed above. For example, a wireless audio receiver such as the wireless audio receiver 104a may be afforded time to compare a local communication channel condition for a wireless communication channel that currently receives the radio frequency signal 110 to respective communication channel conditions for one or more candidate wireless communication channels because a certain amount of synchronization overhead is available to maintain desirable synchronization between the wireless audio transmitter 102 and the wireless audio receiver. In some examples, particular frames or packets for a relevant wireless communication protocol may initiate the condition check process for a wireless communication channel.

The synchronization overhead may be available based on, but not limited to: synchronization signals exchanged between the wireless audio transmitter 102 and the wireless audio receiver, clock synchronization between the wireless audio transmitter 102 and the wireless audio receiver, synchronization of a carrier frequency between the wireless audio transmitter 102 and the wireless audio receiver, channel characteristics (e.g., amplitude, phase, and/or frequency response) between the wireless audio transmitter 102 and the wireless audio receiver, synchronization of frame or data packets between the wireless audio transmitter 102 and the wireless audio receiver, identification of frame markers or other frame structures to maintain frame synchronization, hardware characteristics such as a type of hardware being utilized by the wireless audio transmitter 102 to transmit the radio frequency signal 110, hardware characteristics such as a type of hardware being utilized by the wireless audio receiver to receive the radio frequency signal 110, and/or other timing information between the wireless audio transmitter 102 and the wireless audio receiver.

Turning to the communication channel conditions that might prompt a wireless audio transmitted to independently switch to other candidate communication channels, such communication channel conditions may include one or more conditions related to the first wireless communication channel and/or the respective wireless audio receiver such as, but not limited to: an interference condition for the first wireless communication channel, a signal degradation condition associated with the first wireless communication channel, a non-interference dependent condition associated with the first wireless communication channel, a location condition for a respective wireless audio receiver within the radio frequency environment that might be better suited to a different carrier frequency, and/or another type of condition related to the first wireless communication channel and/or the respective wireless audio receiver. For example, based on a determination that an interference condition for the first wireless communication channel satisfies an interference condition threshold, the one or more wireless audio receivers 104a-n may be configured to independently tune to a second wireless communication channel. The second wireless communication channel may be associated with a second carrier frequency different from the first carrier frequency to receive the radio frequency signal 110. An interference condition may include any one of the following: a noise condition, an interference magnitude condition, a signal-to-noise ratio condition, a quality condition, a bit error ratio (BER) condition, an error vector magnitude (EVM) condition, or another type of interference condition related to a degree of interference for the first wireless communication channel.

In another example, the one or more wireless audio receivers 104a-n may be configured to independently tune to the second wireless communication channel based on a determination that a signal degradation condition associated with the first wireless communication channel satisfies a signal degradation condition threshold. A signal degradation condition may be a condition for a wireless communication channel where no radio frequency signals are being received via the wireless communication channel due to, for example, a radio frequency dropout between a wireless audio receiver and a wireless audio transmitter. For example, a signal degradation condition may include any one of the following: a frequency dropout condition, a communication failure condition, a data packet loss condition, or another type of signal degradation condition related to the first wireless communication channel.

In another example, the one or more wireless audio receivers 104a-n may be configured to independently tune to the second wireless communication channel based on a determination that a non-interference dependent condition associated with the first wireless communication channel satisfies a non-interference dependent condition threshold. For example, a non-interference dependent condition may include any one of the following: a distortion condition, a warping condition, a log likelihood ratio (LLR) condition, or another type of non-interference dependent condition related to the first wireless communication channel.

In yet another example, to provide optimal frequency coverage for the one or more wireless audio receivers 104a-n, the one or more wireless audio receivers 104a-n may be configured to independently tune to the second wireless communication channel based on a local determination that a respective location for the respective wireless audio receiver corresponds to or is best suited to a defined area within the radio frequency environment. The optimal carrier frequency for a defined area may be established or configured manually by creating zones (e.g., audio zones, radio frequency environment zoning, zoning between wireless audio receivers, multiple transmitter configurations, etc.) or it may be independently learned by each respective wireless audio receiver based on an analysis of the received radio frequency signal 110 and other detected environmental factors.

Each of the one or more wireless audio receivers 104a-n may be configured to detect and, optionally, report its position or location within a radio frequency environment. Such location may be detected via a variety of ways as will be apparent to one of ordinary skill in the art and may be a real-time location determined based on a static position or determined dynamically based on movement of the one or more wireless audio receivers 104a-n within the radio frequency environment.

In a non-limiting example, both the wireless audio receiver 104a and the wireless audio receiver 104n may be tuned to a wireless communication channel associated with a particular carrier frequency to receive the radio frequency signal 110 broadcasted by the wireless audio transmitter 102 via the wireless communication channel and one or more other wireless communication channels. The wireless audio receiver 104a may be located a first location within the radio frequency environment for the wireless audio system 100 and the wireless audio receiver 104n may be located a second location within the radio frequency environment. The wireless audio receiver 104a and the wireless audio receiver 104n may both independently determine whether a communication channel condition for a wireless communication channel employed by the respective wireless audio receiver satisfies a communication channel condition threshold.

For example, the wireless audio receiver 104a and the wireless audio receiver 104n may both independently determine whether an interference condition for the wireless communication channel satisfies an interference condition threshold. In this example, a first location for the wireless audio receiver 104a may be associated with a certain amount of interference such that the interference condition for the wireless communication channel satisfies the interference condition threshold for the wireless audio receiver 104a. The second location for the wireless audio receiver 104n may be associated with a different level of interference such that the interference condition for the wireless communication channel does not satisfy the interference condition threshold for the wireless audio receiver 104n. As such, the wireless audio receiver 104a is configured to tune to a different wireless communication channel associated with a different carrier frequency to receive the radio frequency signal 110 while the wireless audio receiver 104n is configured to remain tuned to the original wireless communication channel to receive the radio frequency signal 110.

A communication channel condition (e.g., an interference condition, a signal degradation condition, and/or a non-interference dependent condition) for a wireless communication channel may be determined, for example, based on wireless communication channel measurement device, an antenna measurement device, a radio frequency sensitivity measurement device, a spectrum analyzer device, an electromagnetic interference measurement device, or another type of monitoring device included in the one or more wireless audio receivers 104a-n. Additionally, a communication channel condition threshold (e.g., an interference condition threshold, a signal degradation condition threshold, and/or a non-interference dependent condition threshold) may be determined based on one or more signal metrics for a wireless communication channel.

For example, an interference condition threshold may correspond to a noise threshold, an interference magnitude threshold, a signal-to-noise ratio threshold, a BER threshold, an EVM threshold, or another type of threshold related to an amount of interference. A signal degradation condition threshold may correspond to a frequency dropout threshold, a signal degradation threshold, a data packet loss threshold, or another type of threshold related to identification of a signal degradation. A non-interference dependent condition threshold may correspond to a distortion threshold, a warping threshold, an LLR threshold, or another type of signal metric threshold.

In various examples, a communication channel condition threshold (e.g., an interference condition threshold, a signal degradation condition threshold, and/or a non-interference dependent condition threshold) may be determined as being satisfied and/or triggered based on the communication channel condition threshold persisting (i.e., satisfying the communication channel condition threshold) for a certain interval of time.

Confirming that communication channel conditions persist for predetermined time intervals prevents the wireless audio receivers 104a-n from unnecessary tuning and/or switching from satisfactory wireless communication channels when temporary or intermittent communication channel conditions arise.

The communication channel condition threshold (e.g., the interference condition threshold, the signal degradation condition threshold, and/or the non-interference dependent condition threshold) may be learned and/or trained using one or more machine learning models configured for interference detection. Alternatively, the communication channel condition threshold may be predetermined based on a type of radio frequency environment for a wireless audio receiver. In various examples, the communication channel condition threshold may vary and thus be separately determined based on a type of codec and/or other hardware integrated within a wireless audio receiver.

Each of the one or more wireless audio receivers 104a-n may also be configured to report tuning update data to the wireless audio transmitter 102. The tuning update data may indicate that a respective wireless audio receiver from the one or more wireless audio receivers 104a-n has tuned from a wireless communication channel to a new wireless communication channel. For example, the tuning update data may include a wireless communication channel identifier related to the new wireless communication channel for the respective wireless audio receiver, a carrier frequency value associated with the new wireless communication channel for the respective wireless audio receiver, a wireless audio transmitter identifier related to the respective wireless audio receiver, location data related to the respective wireless audio receiver, communication channel condition data related to the wireless communication channel that triggered tuning to the new wireless communication channel for the respective wireless audio receiver, other data related to the respective wireless audio receiver, other data related to the wireless communication channel, and/or other data related to the new wireless communication channel.

In certain examples, the one or more other wireless communication channels that redundantly transmit the radio frequency signal 110 may include a plurality of wireless communication channels respectively associated with different carrier frequencies. Additionally, the wireless audio transmitter 102 may receive, from a first wireless audio receiver of the one or more wireless audio receivers 104a-n, first tuning update data indicating that the first wireless audio receiver has tuned from the wireless communication channel to a first channel of the plurality of wireless communication channels. The wireless audio transmitter 102 may also receive, from a second wireless audio receiver of the one or more wireless audio receivers 104a-n, second tuning update data indicating that the second wireless audio receiver has tuned from the wireless communication channel to a second channel of the plurality of wireless communication channels. The second wireless communication channel may be associated with a different carrier frequency than the first wireless communication channel. Accordingly, in certain examples, the wireless audio transmitter 102 may receive tuning update data from two or more wireless audio receivers that transition from a wireless communication channel to respectively new and separate wireless communication channels.

In an example, the wireless audio transmitter 102 may transmit the radio frequency signal 110 via at least a first wireless communication channel associated with a first carrier frequency and a second wireless communication channel associated with a second carrier frequency different from the first carrier frequency. Additionally, the wireless audio receiver 104a may be a first wireless audio receiver that receives the radio frequency signal 110 transmitted by the wireless audio transmitter 102 and the wireless audio receiver 104n may be a second wireless audio receiver that also receives the radio frequency signal 110 transmitted by the wireless audio transmitter 102.

The wireless audio receiver 104a may tune to the first wireless communication channel associated with the first carrier frequency or the second wireless communication channel associated with the second carrier frequency to receive the radio frequency signal 110. Furthermore, the wireless audio receiver 104a may independently tune to the first wireless communication channel associated with the first carrier frequency or the second wireless communication channel associated with the second carrier frequency to receive the radio frequency signal 110.

The wireless audio receiver 104a may tune to the first wireless communication channel associated with the first carrier frequency to receive the radio frequency signal 110 and the wireless audio receiver 104n may also tune to the first wireless communication channel associated with the first carrier frequency to receive the radio frequency signal 110.

In another example, the wireless audio receiver 104a may tune to the first wireless communication channel associated with the first carrier frequency to receive the radio frequency signal 110 and the wireless audio receiver 104n may tune to the second wireless communication channel associated with the second carrier frequency to receive the radio frequency signal 110.

In another example, the wireless audio receiver 104a may tune to the second wireless communication channel associated with the second carrier frequency to receive the radio frequency signal 110 and the wireless audio receiver 104n may tune to the first wireless communication channel associated with the first carrier frequency to receive the radio frequency signal 110.

In yet another example, the wireless audio receiver 104a may tune to the second wireless communication channel associated with the second carrier frequency to receive the radio frequency signal 110 and the wireless audio receiver 104n may also tune to the second wireless communication channel associated with the second carrier frequency to receive the radio frequency signal 110.

The wireless audio receiver 104a and the wireless audio receiver 104n may also independently tune to a different wireless communication channel based on respective communication channel conditions. For instance, in an example where the wireless audio receiver 104a and the wireless audio receiver 104n are both tuned to the first wireless communication channel associated with the first carrier frequency to receive the radio frequency signal 110, the wireless audio receiver 104a may independently tune to the second wireless communication channel associated with the second carrier frequency to receive the radio frequency signal 110 based on a determination that a communication channel condition for the first wireless communication channel satisfies a communication channel condition threshold. Additionally, the wireless audio receiver 104n may independently tune to the second wireless communication channel associated with the second carrier frequency to receive the radio frequency signal 110 based on a second determination that a second communication channel condition for the first wireless communication channel satisfies a second communication channel condition threshold.

The second communication channel condition may be different than the communication channel condition. In an alternate example, the second communication channel condition may correspond to the communication channel condition. Additionally or alternatively, the second communication channel condition threshold may be different than the communication channel condition threshold. In an alternate example, the second communication channel condition threshold may correspond to the communication channel condition threshold.

In an example where the wireless audio transmitter 102 additionally transmits the radio frequency signal 110 via at least a third wireless communication channel associated with a third carrier frequency different from the first carrier frequency and the second carrier frequency, the wireless audio receiver 104a and/or the wireless audio receiver 104n may alternatively independently tune to the third wireless communication channel associated with the third carrier frequency to receive the radio frequency signal 110. For example, based on a second determination that a second communication channel condition for the first wireless communication channel satisfies a second communication channel condition threshold, the wireless audio receiver 104n may alternatively tune to the third wireless communication channel associated with the third carrier frequency to receive the radio frequency signal 110.

In certain examples, the wireless audio transmitter 102 may be configured as two or more wireless audio transmitters. For example, the wireless audio transmitter 102 may include a first wireless audio transmitter that transmits the radio frequency signal 110 via the first wireless communication channel associated with the first carrier frequency. Additionally, the wireless audio transmitter 102 may include at least a second wireless audio transmitter that transmits the radio frequency signal 110 via the second wireless communication channel associated with the second carrier frequency different from the first carrier frequency.

It is to be appreciated that, in certain examples, the wireless audio transmitter 102 may include more than two wireless audio transmitters. For example, the wireless audio transmitter 102 may additionally include at least a third wireless audio transmitter that transmits the radio frequency signal 110 via the third wireless communication channel associated with the third carrier frequency different from the first carrier frequency and the second carrier frequency.

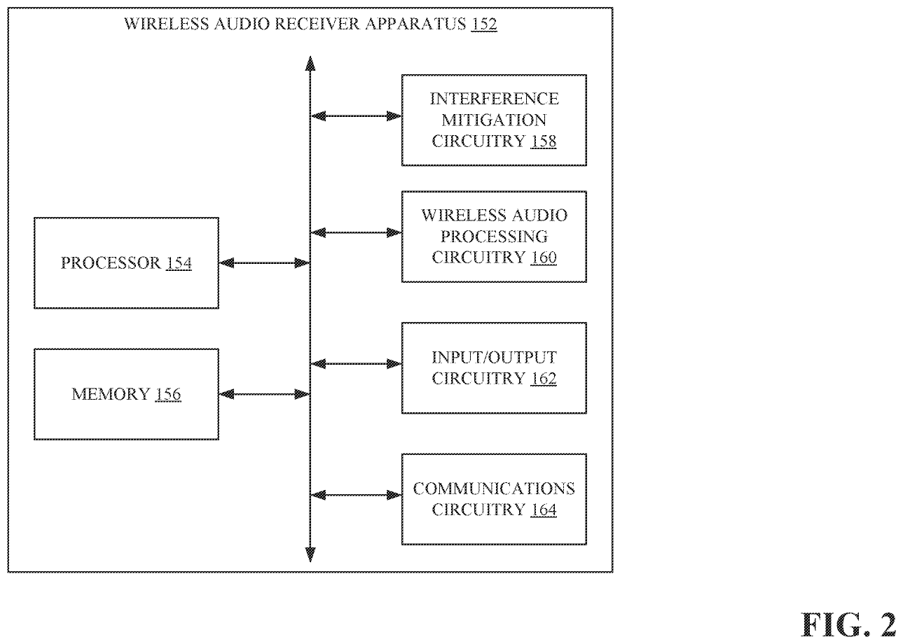

FIG. 2 illustrates an example wireless audio receiver apparatus 152 configured in accordance with one or more embodiments of the present disclosure. The wireless audio receiver apparatus 152 may be configured to perform one or more techniques described in FIG. 1 and/or one or more other techniques described herein. In one or more embodiments, the wireless audio receiver apparatus 152 may be embedded in a wireless audio receiver from the one or more wireless audio receivers 104a-n.

In some cases, the wireless audio receiver apparatus 152 may be a computing system communicatively coupled with, and configured to control, one or more circuit modules associated with wireless audio processing. For example, the wireless audio receiver apparatus 152 may be a computing system communicatively coupled with one or more circuit modules related to wireless audio processing. The wireless audio receiver apparatus 152 may comprise or otherwise be in communication with a processor 154, a memory 156, interference mitigation circuitry 158, wireless audio processing circuitry 160, input/output circuitry 162, and/or communications circuitry 164. In some examples, the processor 154 (which may comprise multiple or co-processors or any other processing circuitry associated with the processor) may be in communication with the memory 156.

The memory 156 may comprise non-transitory memory circuitry and may comprise one or more volatile and/or non-volatile memories. In some examples, the memory 156 may be an electronic storage device (e.g., a computer readable storage medium) configured to store data that may be retrievable by the processor 154. In some examples, the data stored in the memory 156 may comprise radio frequency signal data, audio data, stereo audio signal data, mono audio signal data, or the like, for enabling the apparatus to carry out various functions or methods in accordance with embodiments of the present invention, described herein.

In some examples, the processor 154 may be embodied in a number of different ways. For example, the processor 154 may be embodied as one or more of various hardware processing means such as a central processing unit (CPU), a microprocessor, a coprocessor, a digital signal processor (DSP), an Advanced RISC Machine (ARM), a field programmable gate array (FPGA), a neural processing unit (NPU), a graphics processing unit (GPU), a system on chip (SoC), a cloud server processing element, a controller, or a processing element with or without an accompanying DSP. The processor 154 may also be embodied in various other processing circuitry including integrated circuits such as, for example, a microcontroller unit (MCU), an ASIC (application specific integrated circuit), a hardware accelerator, a cloud computing chip, or a special-purpose electronic chip. Furthermore, in some examples, the processor 154 may comprise one or more processing cores configured to perform independently. A multi-core processor may enable multiprocessing within a single physical package. Additionally or alternatively, the processor 154 may comprise one or more processors configured in tandem via the bus to enable independent execution of instructions, pipelining, and/or multithreading.

In an example, the processor 154 may be configured to execute instructions, such as computer program code or instructions, stored in the memory 156 or otherwise accessible to the processor 154. Alternatively or additionally, the processor 154 may be configured to execute hard-coded functionality. As such, whether configured by hardware or software instructions, or by a combination thereof, the processor 154 may represent a computing entity (e.g., physically embodied in circuitry) configured to perform operations according to an embodiment of the present invention described herein. For example, when the processor 154 is embodied as an CPU, DSP, ARM, FPGA, ASIC, or similar, the processor may be configured as hardware for conducting the operations of an embodiment of the invention. Alternatively, when the processor 154 is embodied to execute software or computer program instructions, the instructions may specifically configure the processor 154 to perform the algorithms and/or operations described herein when the instructions are executed. However, in some cases, the processor 154 may be a processor of a device specifically configured to employ an embodiment of the present invention by further configuration of the processor using instructions for performing the algorithms and/or operations described herein. The processor 154 may further comprise a clock, an arithmetic logic unit (ALU) and logic gates configured to support operation of the processor 154, among other things.

In one or more examples, the wireless audio receiver apparatus 152 may comprise the interference mitigation circuitry 158. The interference mitigation circuitry 158 may be any means embodied in either hardware or a combination of hardware and software that is configured to perform one or more functions disclosed herein related to the one or more wireless audio receivers 104a-n to provide transmit redundancy for a wireless audio system. In one or more examples, the wireless audio receiver apparatus 152 may comprise the wireless audio processing circuitry 160. The wireless audio processing circuitry 160 may be any means embodied in either hardware or a combination of hardware and software that is configured to perform one or more functions disclosed herein related to audio processing of the radio frequency signal 110. In one or more examples, wireless audio processing circuitry 160 may be configured to perform audio processing to convert one or more portions of the radio frequency signal 110 into the audio signal 406 for the listening device 402.

In certain examples, the wireless audio receiver apparatus 152 may comprise the input/output circuitry 162 that may, in turn, be in communication with processor 154 to provide output to the user and, in some examples, to receive an indication of a user input. The input/output circuitry 162 may comprise a user interface and may comprise a display. In some examples, the input/output circuitry 162 may also comprise a keyboard, a touch screen, touch areas, soft keys, buttons, knobs, or other input/output mechanisms.

In certain examples, the wireless audio receiver apparatus 152 may comprise the communications circuitry 164. The communications circuitry 164 may be any means embodied in either hardware or a combination of hardware and software that is configured to receive and/or transmit data from/to a network and/or any other device or module in communication with the wireless audio receiver apparatus 152. In this regard, the communications circuitry 164 may comprise, for example, an antenna or one or more other communication devices for enabling communications with a wired or wireless communication network. For example, the communications circuitry 164 may comprise antennae, one or more network interface cards, buses, switches, routers, modems, and supporting hardware and/or software, or any other device suitable for enabling communications via a network. Additionally or alternatively, the communications circuitry 164 may comprise the circuitry for interacting with the antenna/antennae to cause transmission of signals via the antenna/antennae or to handle receipt of signals (e.g., the radio frequency signal 110) received via the antenna/antennae.

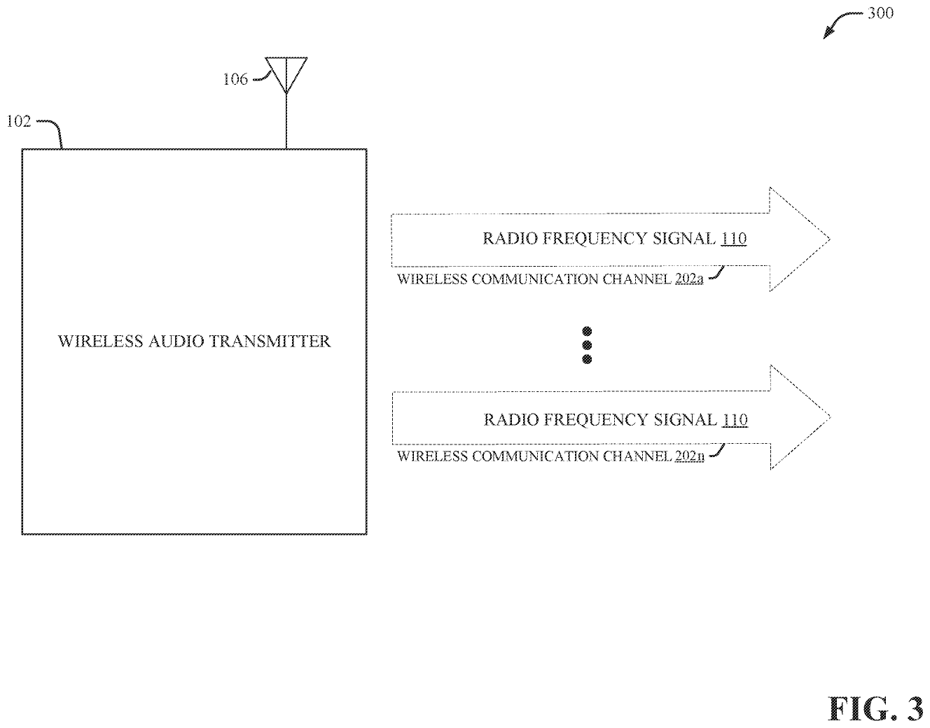

FIG. 3 illustrates a wireless audio transmitter system 300 that facilitates transmit redundancy for the wireless audio system 100 according to one or more embodiments of the present disclosure. The wireless audio transmitter system 300 includes the wireless audio transmitter 102. To facilitate transmit redundancy of the radio frequency signal 110, the wireless audio transmitter 102 may simultaneously transmit the radio frequency signal 110 at two or more carrier frequencies via the antenna 106. For instance, the wireless audio transmitter 102 may simultaneously transmit the radio frequency signal 110 via two or more wireless communication channels 202a-n. In some examples, the wireless audio transmitter system 300 includes multiple antennae for simultaneously transmitting the radio frequency signal 110 at multiple carrier frequencies.

The wireless communication channels 202a may be, for example, a first wireless communication channel associated with a first carrier frequency that broadcasts the radio frequency signal 110. The wireless communication channels 202n may also be, for example, a second wireless communication channel associated with a second carrier frequency different than the first carrier frequency that redundantly broadcasts the radio frequency signal 110. It is to be appreciated that, in certain examples, the wireless audio transmitter 102 may redundantly broadcast the radio frequency signal 110 via more than two wireless communication channels respectively associated with unique carrier frequencies.

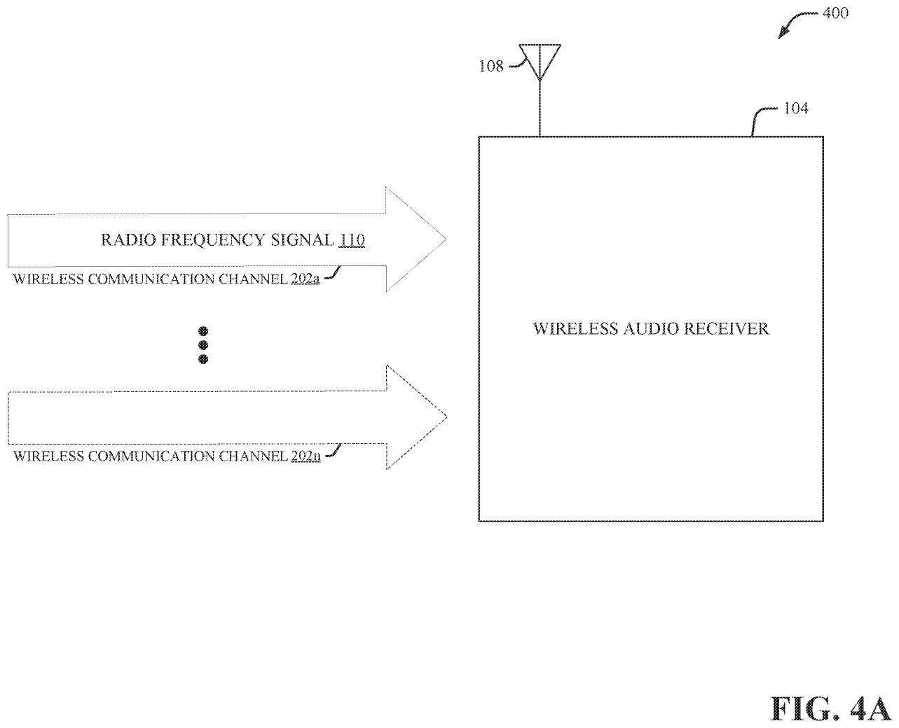

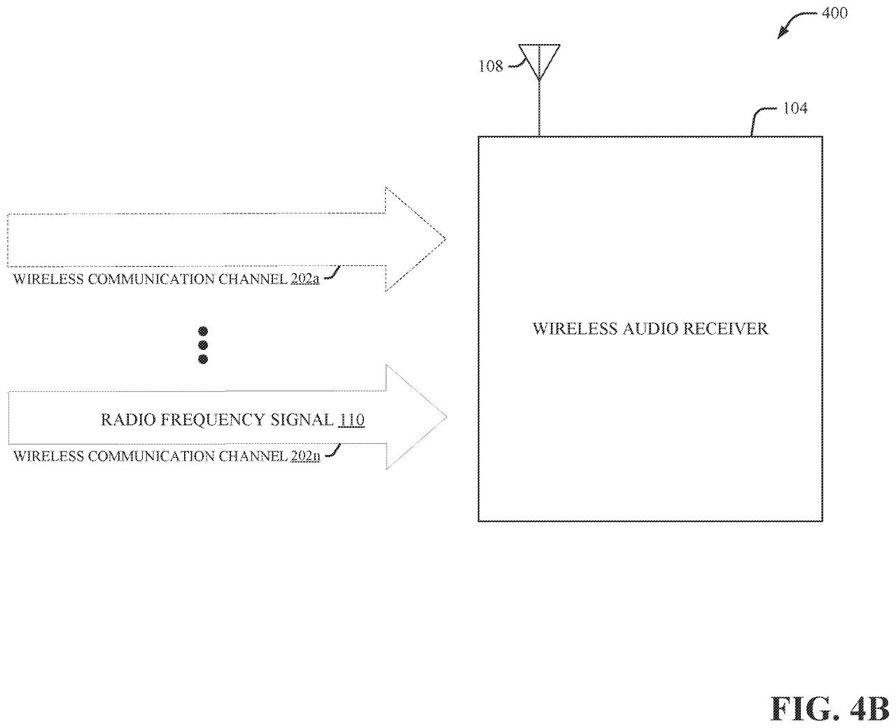

FIG. 4A illustrates a wireless audio receiver system 400 that facilitates transmit redundancy for the wireless audio system 100 according to one or more embodiments of the present disclosure. The wireless audio receiver system 400 includes a wireless audio receiver 104. The wireless audio receiver 104 may correspond to a wireless audio receiver (e.g., the wireless audio receiver 104a or the wireless audio receiver 104n) from the one or more wireless audio receivers 104a-n in the wireless audio system 100.

The depicted wireless audio receiver 104 may utilize an antenna 108 of the wireless audio receiver 104 to tune to the wireless communication channel 202a associated with a first carrier frequency to receive the radio frequency signal 110. In one example, the wireless audio receiver 104 may select and/or tune to the wireless communication channel 202a based on a wireless communication channel scan operation performed by the wireless audio receiver system 400. The wireless communication channel scan operation may scan for any redundant wireless communication channels being employed by the wireless audio transmitter 102 to broadcast the radio frequency signal 110.

The wireless audio receiver 104 may also establish a connection with the wireless audio transmitter 102 via the wireless communication channel scan operation. For example, the wireless audio receiver 104 may establish a connection with the wireless audio transmitter 102 via the wireless communication channel 202a based on the wireless communication channel scan operation. The wireless audio receiver 104 may establish an initial connection via the wireless communication channel 202a based on one or more predefined wireless channel rules. In an example, the one or more predefined wireless channel rules may include one or more spacing rules to optimize usage of wireless communication channels and/or to provide an optimal separation between wireless communication channels being employed by respective wireless audio receivers. In another example, the one or more predefined wireless channel rules may additionally or alternatively include timing rules such that a communication channel condition for a wireless communication channel is satisfied for a certain period of time before being tuned to a different wireless communication channel. In this way, tuning of the wireless audio receiver 104 may be configured to prevent undue switching of wireless communication channels due to intermittent or temporary interference related to a wireless communication channel.

Upon determining that a communication channel condition for the wireless communication channel 202a satisfies a communication channel condition threshold, the wireless audio receiver 104 is configured to utilize the antenna 108 to tune to the wireless communication channel 202n associated with a second carrier frequency to receive the radio frequency signal 110, as illustrated in FIG. 4B. For example, based on a determination that an interference condition for the wireless communication channel 202a satisfies an interference condition threshold, the wireless audio receiver 104 may utilize the antenna 108 of the wireless audio receiver 104 to tune to the wireless communication channel 202n associated with a second carrier frequency to receive the radio frequency signal 110. To provide optimized tuning for the wireless audio receiver 104, the wireless audio receiver 104 may utilize the antenna 108 of the wireless audio receiver 104 to tune to the wireless communication channel 202n based on the communication channel condition threshold satisfying the communication channel condition threshold for a certain interval of time.

The second carrier frequency may be different than the first carrier frequency. In a non-limiting example, the first carrier frequency may correspond to 174 MHz and the second carrier frequency may correspond to 244 MHz. However, it is to be appreciated that the first carrier frequency and/or the second carrier frequency may be different carrier frequency values within a frequency range from about 174 MHz to about 6 GHz, for example. In certain examples, the wireless audio receiver 104 may switch between a first antenna associated with the wireless communication channel 202a and a second antenna associated with the second wireless communication channel 202n based on the determination that the communication channel condition for the wireless communication channel 202a satisfies the communication channel condition threshold.

Additionally, it is to be appreciated that the wireless audio receiver 104 may utilize the antenna 108 of the wireless audio receiver 104 to tune to the wireless communication channel 202n based on one or more other conditions for the wireless communication channel 202a. For example, the wireless audio receiver 104 may tune to the wireless communication channel 202n based on detection of a signal degradation condition, a non-interference dependent condition, or another undesirable condition associated with the wireless communication channel 202a.

In various examples, the wireless audio receiver 104 may establish the connection via the wireless communication channel 202n based on the one or more predefined wireless channel rules. For example, based on a determination that a communication channel condition for the wireless communication channel 202a satisfies a communication channel condition threshold, the wireless audio receiver 104 may select the wireless communication channel 202n from a list of wireless communication channels and/or based on the one or more predefined wireless channel rules as further described herein. In some examples, a wireless audio receiver 104 may iterate the wireless communication channel selection process through multiple hops with each hop involving a comparison of a communication channel condition for each respective redundantly transmitted wireless communication channel to a respective wireless communication channel threshold.

In some examples, a determination that a communication channel condition for the wireless communication channel 202a satisfies a communication channel condition threshold may be determined relative to separate communication channel conditions for the wireless communication channel 202n. For example, in response to a determination that a communication channel condition for the wireless communication channel 202a satisfies a communication channel condition, the wireless audio receiver 104 may additionally compare a separate communication channel condition for the second wireless communication channel to the communication channel condition threshold. Furthermore, based on a determination that the separate communication channel condition for the second wireless communication channel does not satisfy the communication channel condition threshold, the wireless audio receiver 104 may be configured to utilize the antenna 108 to tune to the wireless communication channel 202n associated with the second carrier frequency to receive the radio frequency signal 110. However, based on a determination that the separate communication channel condition for the second wireless communication channel satisfies the communication channel condition threshold, the wireless audio receiver 104 may maintain tuning via the wireless communication channel 202a or the wireless audio receiver 104 may tune to a different wireless communication channel with more desirable communication channel conditions.

In some examples, the wireless audio receiver 104 may alternatively compare the separate communication channel condition for the second wireless communication channel to a communication channel improvement threshold that is different than the communication channel condition threshold. Additionally, based on a determination that the separate communication channel condition for the second wireless communication channel satisfies the communication channel improvement threshold, the wireless audio receiver 104 may be configured to utilize the antenna 108 to tune to the wireless communication channel 202n associated with the second carrier frequency to receive the radio frequency signal 110. The communication channel improvement threshold may be determined based on one or more signal quality metrics for a wireless communication channel. For example, the communication channel improvement threshold may be utilized to indicate a certain degree of improvement that is achieved by switching wireless communication channels to receive the radio frequency signal 110. In some examples, the communication channel improvement threshold may be based on a certain degree of predicted improvement with respect to interference, signal degradation, and/or another type of communication channel condition. As such, the wireless audio receiver 104 may retune to the wireless communication channel 202n based on one or more informed decisions that the wireless communication channel 202n may be adequately utilized for receiving the radio frequency signal 110 and/or that the wireless communication channel 202n is more favorable for receiving the radio frequency signal 110 than the wireless communication channel 202a.

In certain examples, the wireless audio transmitter 102 may receive data from a wireless audio receiver from the one or more wireless audio receivers 104a-n. For example, the wireless audio transmitter 102 may receive data from the wireless audio receiver 104 based on or triggered by tuning of the wireless audio receiver 104 from the wireless communication channel 202a to the wireless communication channel 202n in response to the wireless audio receiver 104 determining that a communication channel condition of wireless communication channel 202a satisfies a communication channel condition threshold.

The data received from the wireless audio receiver 104 is referred to as “tuning update data” and may indicate that the wireless audio transmitter 102 has tuned from a wireless communication channel (e.g., the wireless communication channel 202a) to a new wireless communication channel (e.g., the wireless communication channel 202n). The tuning update data may include a wireless communication channel identifier related to the new wireless communication channel for the wireless audio receiver 104, a carrier frequency value associated with the new wireless communication channel for the wireless audio receiver 104, a wireless audio transmitter identifier related to the wireless audio receiver 104, location data related to the wireless audio receiver 104, communication channel condition data related to the wireless communication channel (e.g., the wireless communication channel 202a) that triggered tuning to the new wireless communication channel for the wireless audio receiver 104, other data related to the wireless audio receiver 104, other data related to the wireless communication channel, and/or other data related to the new wireless communication channel.

In this regard, the wireless audio transmitter 102 may redundantly transmit the radio frequency signal 110 via the wireless communication channel 202a and the wireless communication channel 202n. Additionally, the wireless audio receiver 104 may initially be tuned to the wireless communication channel 202a to receive the radio frequency signal 110. However, after the wireless audio receiver 104 is tuned to the wireless communication channel 202n based on a determination that a communication channel condition for the wireless communication channel 202a satisfies a communication channel condition threshold, the wireless audio transmitter 102 may receive tuning update data from the wireless audio receiver 104. The tuning update data received by the wireless audio transmitter 102 may indicate that the wireless audio receiver 104 has tuned from the wireless communication channel 202a to the wireless communication channel 202n.

In a non-limiting example, the wireless audio transmitter 102 may receive, from the wireless audio receiver 104, a first wireless communication channel identifier related to the wireless communication channel 202a based on tuning of the wireless audio receiver 104 via the wireless communication channel 202a. Then, based on a switch of the tuning of the wireless audio receiver 104 to the wireless communication channel 202n, the wireless audio transmitter 102 may receive, from the wireless audio receiver 104, a second wireless communication channel identifier related to the wireless communication channel 202n. In various examples, the wireless audio transmitter 102 may additionally or alternatively receive communication channel condition data related to tuning of the wireless audio receiver 104 from the wireless communication channel 202a to the wireless communication channel 202n and/or other tuning update data as further disclosed herein.

The wireless audio transmitter 102 may also be configured to receive respective tuning update data from respective wireless audio transmitters in a radio frequency environment for a wireless audio system. For example, the wireless audio transmitter 102 may receive, from the wireless audio receiver 104a, first tuning update data based on tuning of the wireless audio receiver 104a from a wireless communication channel (e.g., the wireless communication channel 202a) to a new wireless communication channel (e.g., the wireless communication channel 202n). Additionally, the wireless audio transmitter 102 may receive, from the wireless audio receiver 104n, second tuning update data based on tuning of the wireless audio receiver 104n from a wireless communication channel (e.g., the wireless communication channel 202a) to a new wireless communication channel (e.g., the wireless communication channel 202n).

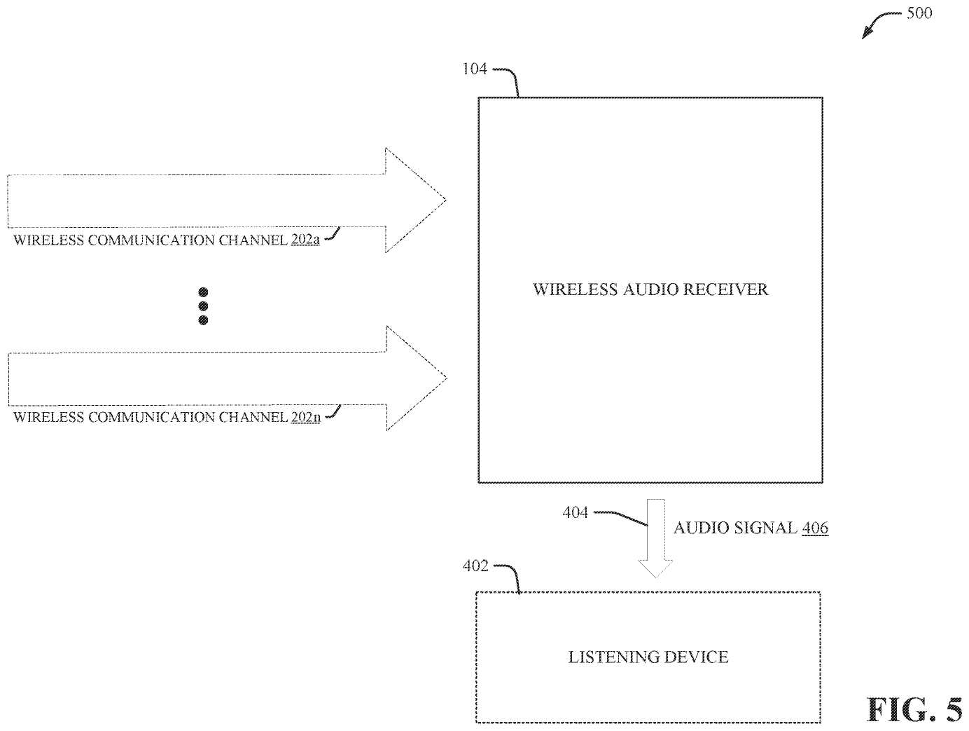

FIG. 5 illustrates a wireless audio receiver system 500 that facilitates transmit redundancy for the wireless audio system 100 according to one or more embodiments of the present disclosure. The wireless audio receiver system 500 includes the wireless audio receiver 104 and a listening device 402. The wireless audio receiver 104 may be communicatively coupled to the listening device 402 via an audio channel 404. The audio channel 404 may be a wireless audio channel or a wired audio channel. The listening device 402 may be an in-ear monitor, headphones, earphones, speakers, or another type of listening device. The wireless audio receiver 104 may transmit an audio signal 406 to the listening device via the audio channel 404. The audio signal 406 may include audio data associated with one or more portions of the radio frequency signal 110 received via a wireless communication channel from the two or more wireless communication channels 202a-n.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices/entities, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time.

In some example embodiments, retrieval, loading, and/or execution may be performed in parallel such that multiple instructions are retrieved, loaded, and/or executed together. Thus, such embodiments may produce specifically-configured machines performing the steps or operations specified in the block diagrams and flowchart illustrations. Accordingly, the block diagrams and flowchart illustrations support various combinations of embodiments for performing the specified instructions, operations, or steps.

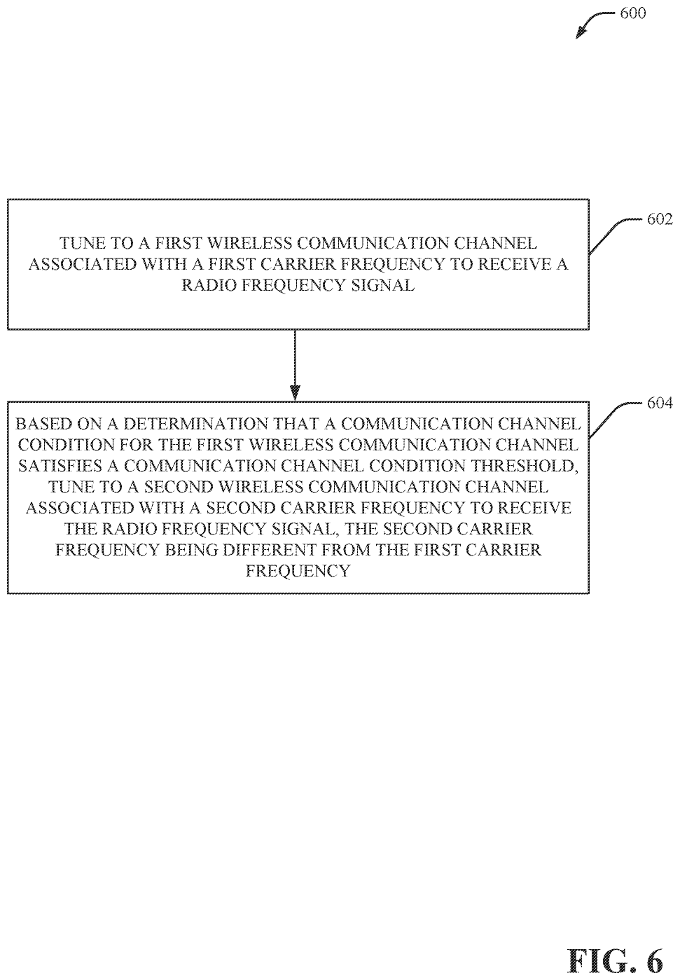

FIG. 6 is a flowchart diagram of an example process 600, for mitigating interference related to a radio frequency signal received by a wireless audio receiver, in accordance with, for example, a wireless audio receiver apparatus 152 illustrated in FIG. 2. Via the various operations of process 600, the wireless audio receiver apparatus 152 enhances quality and/or reliability of audio associated with the radio frequency signal. The process 600 begins at operation 602 that tunes to a first wireless communication channel associated with a first carrier frequency to receive a radio frequency signal. For example, in order to receive the radio frequency signal via the first carrier frequency, an antenna and/or tuning circuitry of the wireless audio receiver is tuned to the first wireless communication channel such that the first carrier frequency is selected as a mode of communication for the wireless audio receiver. Based on a determination that a communication channel condition for the first wireless communication channel satisfies a communication channel condition threshold, operation 604 tunes to a second wireless communication channel associated with a second carrier frequency to receive the radio frequency signal, the second carrier frequency being different from the first carrier frequency. Additionally, the operation 604 tunes to the second wireless communication channel based on a determination that an interference condition for the first wireless communication channel satisfies an interference condition threshold. In embodiments in which the wireless audio receiver apparatus 152 comprises two or more antennas (i.e., receive antenna diversity), the tuning operation 604 includes switching to an alternative antenna that is tuned to the second wireless communication channel. In some examples, the interference condition includes: a noise condition, an interference magnitude condition, a signal-to-noise ratio condition, a quality condition, a BER condition, an EVM condition, or another type of interference condition related to a degree of interference for the first wireless communication channel.

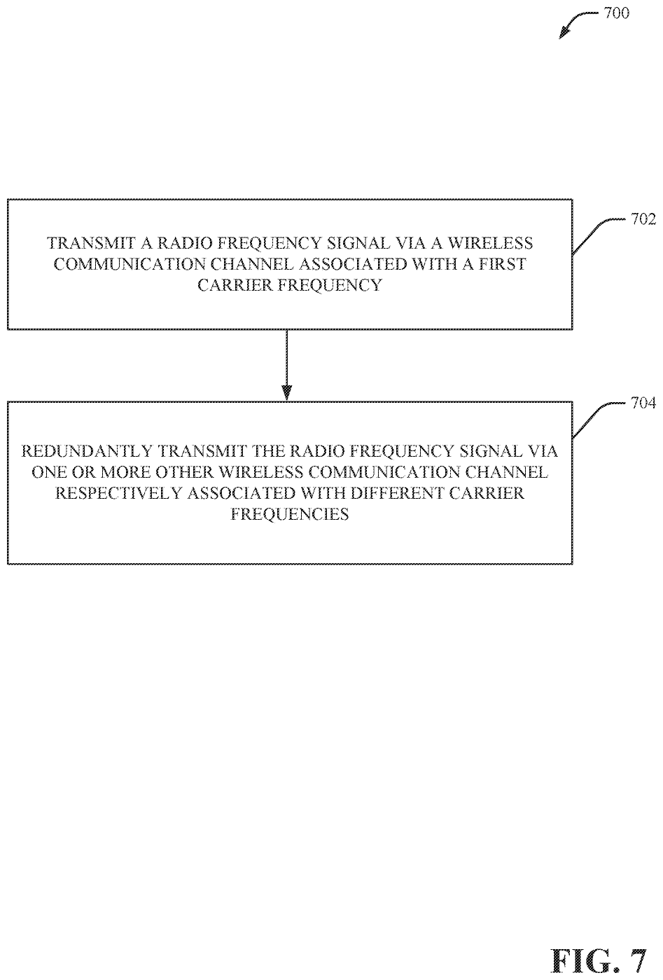

FIG. 7 is a flowchart diagram of an example process 700, for mitigating interference related to radio frequency signals transmitted by a wireless audio transmitter, in accordance with, for example, the wireless audio transmitter 102. Via the various operations of process 700, the wireless audio transmitter 102 enhances quality and/or reliability of audio received with a wireless audio receiver. The process 700 begins at operation 702 that transmits a radio frequency signal via a wireless communication channel associated with a first carrier frequency. At, operation 704 the radio frequency signal is redundantly transmitted via one or more other wireless communication channels respectively associated with different carrier frequencies.

In some examples, the radio frequency signal redundantly transmitted via the wireless communication channel and the one or more other wireless communication channels includes a corresponding audio payload. In some examples, the radio frequency signal redundantly transmitted via the wireless communication channel and the one or more other wireless communication channels includes encoded information within a sideband portion of the radio frequency signal that corresponds to the audio payload. In some examples, the radio frequency signal redundantly transmitted via the wireless communication channel and the one or more other wireless communication channels additionally or alternatively includes control information corresponding to the respective wireless communication channel.

Although example processing systems have been described in the figures herein, implementations of the subject matter and the functional operations described herein may be implemented in other types of digital electronic circuitry, or in computer software, firmware, or hardware, including the structures disclosed in this specification and their structural equivalents, or in combinations of one or more of them.

Embodiments of the subject matter and the operations described herein may be implemented in digital electronic circuitry, or in computer software, firmware, or hardware, including the structures disclosed in this specification and their structural equivalents, or in combinations of one or more of them. Embodiments of the subject matter described herein may be implemented as one or more computer programs, i.e., one or more modules of computer program instructions, encoded on computer-readable storage medium for execution by, or to control the operation of, information/data processing apparatus. Alternatively, or in addition, the program instructions may be encoded on an artificially-generated propagated signal, e.g., a machine-generated electrical, optical, or electromagnetic signal, which is generated to encode information/data for transmission to suitable receiver apparatus for execution by an information/data processing apparatus. A computer-readable storage medium may be, or be included in, a computer-readable storage device, a computer-readable storage substrate, a random or serial access memory array or device, or a combination of one or more of them. Moreover, while a computer-readable storage medium is not a propagated signal, a computer-readable storage medium may be a source or destination of computer program instructions encoded in an artificially-generated propagated signal. The computer-readable storage medium may also be, or be included in, one or more separate physical components or media (e.g., multiple CDs, disks, or other storage devices).

A computer program (also known as a program, software, software application, script, or code) may be written in any form of programming language, including compiled or interpreted languages, declarative or procedural languages, and it may be deployed in any form, including as a stand-alone program or as a module, component, subroutine, object, or other unit suitable for use in a computing environment. A computer program may, but need not, correspond to a file in a file system. A program may be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program may be deployed to be executed on one computer or on multiple computers that are located at one site or distributed across multiple sites and interconnected by a communication network.

The processes and logic flows described herein may be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory, a random access memory, or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

The term “or” is used herein in both the alternative and conjunctive sense, unless otherwise indicated. The terms “illustrative,” “example,” and “exemplary” are used to be examples with no indication of quality level. Like numbers refer to like elements throughout.

The term “comprising” means “including but not limited to,” and should be interpreted in the manner it is typically used in the patent context. Use of broader terms such as comprises, includes, and having should be understood to provide support for narrower terms, such as consisting of, consisting essentially of, comprised substantially of, and/or the like.

The phrases “in one embodiment,” “according to one embodiment,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

While this specification contains many specific implementation details, these should not be construed as limitations on the scope of any disclosures or of what may be claimed, but rather as description of features specific to particular embodiments of particular disclosures. Certain features that are described herein in the context of separate embodiments may also be implemented in combination in a single embodiment.

Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in incremental order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems may generally be integrated together in a product or packaged into multiple products.

Thus, particular embodiments of the subject matter have been described.

Other embodiments are within the scope of the following claims. In some cases, the actions recited in the claims may be performed in a different order and still achieve desirable results. In addition, the processes depicted in the accompanying figures do not necessarily require the particular order shown, or incremental order, to achieve desirable results, unless described otherwise. In certain implementations, multitasking and parallel processing may be advantageous.

Clause 1. A system configured to improve received audio quality communicated to an in-ear monitor device, the system comprising a wireless audio transmitter and a wireless audio receiver.

Clause 2. The system of clause 1, wherein the wireless audio transmitter is configured to transmit a radio frequency signal via a first wireless communication channel associated with a first carrier frequency and a second wireless communication channel associated with a second carrier frequency different from the first carrier frequency.

Clause 3. The system of any one of clauses 1-2, wherein the wireless audio receiver is communicatively coupled to the in-ear monitor device.

Clause 4. The system of any one of clauses 1-3, wherein the wireless audio receiver is configured to: receive the radio frequency signal transmitted by the wireless audio transmitter.

Clause 5. The system of any one of clauses 1-4, wherein the wireless audio receiver is configured to: tune to the first wireless communication channel associated with the first carrier frequency to receive the radio frequency signal.

Clause 6. The system of any one of clauses 1-5, wherein the wireless audio receiver is configured to: based on a determination that a communication channel condition for the first wireless communication channel satisfies a communication channel condition threshold, tune to the second wireless communication channel associated with the second carrier frequency to receive the radio frequency signal.

Clause 7. The system of any one of clauses 1-6, wherein the wireless audio receiver is configured to: receive, from the wireless audio receiver, tuning update data after the wireless audio receiver has tuned to the second wireless communication channel associated with the second carrier frequency.

Clause 8. The system of any one of clauses 1-7, wherein the tuning update data comprises communication channel condition data related to tuning of the wireless audio receiver from the first wireless communication channel to the second wireless communication channel.

Clause 9. The system of any one of clauses 1-8, wherein the tuning update data comprises a wireless communication channel identifier associated with the second wireless communication channel.

Clause 10. The system of any one of clauses 1-9, wherein the wireless audio receiver is configured to: output an audio signal associated with the radio frequency signal to the in-ear monitor device.

Clause 11. The system of any one of clauses 1-10, wherein the wireless audio receiver is configured to: based on the determination that the communication channel condition for the first wireless communication channel satisfies the communication channel condition threshold, alter tuning of an antenna configured for wide-band tuning.

Clause 12. The system of any one of clauses 1-11, wherein the wireless audio receiver is configured to: tune to the second wireless communication channel based on a determination that an interference condition for the first wireless communication channel satisfies an interference condition threshold.

Clause 13. The system of any one of clauses 1-12, wherein the wireless audio receiver is configured to: tune to the second wireless communication channel based on a signal degradation condition associated with the first wireless communication channel.

Clause 14. The system of any one of clauses 1-13, wherein the wireless audio receiver is configured to: tune to the second wireless communication channel based on a non-interference dependent condition associated with the first wireless communication channel.

Clause 15. The system of any one of clauses 1-14, wherein the wireless audio receiver is configured to: tune to the second wireless communication channel based on the communication channel condition threshold satisfying the communication channel condition threshold for a certain interval of time.

Clause 16. The system of any one of clauses 1-15, wherein the wireless audio receiver is configured to: select the first wireless communication channel based on a wireless communication channel scan operation.

Clause 17. The system of any one of clauses 1-16, wherein the wireless audio receiver is configured to: establish a connection with the wireless audio transmitter via the first wireless communication channel based on a wireless communication channel scan operation.

Clause 18. The system of any one of clauses 1-17, wherein the wireless audio receiver is configured to: switch between a first antenna associated with the first wireless communication channel and a second antenna associated with the second wireless communication channel based on the determination that the communication channel condition for the first wireless communication channel satisfies the communication channel condition threshold.

Clause 19. The system of any one of clauses 1-18, wherein the wireless audio receiver is configured to: group the wireless audio receiver with one or more other wireless audio receivers based on a wireless audio receiving grouping operation, wherein the one or more other wireless audio receivers independently tune to the first wireless communication channel or the second wireless communication channel to receive the radio frequency signal.

Clause 20. The system of any one of clauses 1-19, wherein the wireless audio receiver is a first wireless audio receiver, and wherein the system further comprises: a second wireless audio receiver configured to receive the radio frequency signal transmitted by the wireless audio transmitter and/or tune to the first wireless communication channel associated with the first carrier frequency to receive the radio frequency signal.

Clause 21. The system of clause 20, wherein the second wireless audio receiver is configured to: based on a second determination that a second communication channel condition for the first wireless communication channel satisfies a second communication channel condition threshold, tune to the second wireless communication channel associated with the second carrier frequency to receive the radio frequency signal.

Clause 22. The system of clause 21, wherein the second communication channel condition is different than the communication channel condition, and wherein the second communication channel condition threshold is different than the communication channel condition threshold.

Clause 23. The system of any one of clauses 21-22, wherein the second communication channel condition threshold is different than the communication channel condition threshold.

Clause 24. The system of any one of clauses 20-23, wherein the wireless audio transmitter is further configured to transmit the radio frequency signal via a third wireless communication channel associated with a third carrier frequency different from the first carrier frequency and the second carrier frequency.

Clause 25. The system of clause 24, wherein the second wireless audio receiver is further configured to: based on a second determination that a second communication channel condition for the first wireless communication channel satisfies a second communication channel condition threshold, tune to the third wireless communication channel associated with the third carrier frequency to receive the radio frequency signal.

Clause 26. The system of any one of clauses 1-19, wherein the wireless audio receiver is a first wireless audio receiver, and wherein the system further comprises: a second wireless audio receiver configured to receive the radio frequency signal transmitted by the wireless audio transmitter and/or tune to the second wireless communication channel associated with the second carrier frequency to receive the radio frequency signal.

Clause 27. The system of any one of clauses 1-19, wherein the wireless audio transmitter is further configured to transmit the radio frequency signal via a third wireless communication channel associated with a third carrier frequency different from the first carrier frequency and the second carrier frequency, and wherein the second wireless audio receiver is configured to: based on a second determination that a second communication channel condition for the first wireless communication channel satisfies a second communication channel condition threshold, tune to the third wireless communication channel associated with the third carrier frequency to receive the radio frequency signal.

Clause 28. The system of any one of clauses 1-27, wherein the wireless audio transmitter comprises: a first wireless audio transmitter and a second wireless audio transmitter.

Clause 29. The system of clause 28, wherein the first wireless audio transmitter is configured to transmit the radio frequency signal via the first wireless communication channel associated with the first carrier frequency.

Clause 30. The system of any one of clauses 28-29, wherein the second wireless audio transmitter is configured to transmit the radio frequency signal via the second wireless communication channel associated with the second carrier frequency different from the first carrier frequency.

Clause 31. The system of any one of clauses 28-30, wherein the wireless audio receiver is configured to: based on the determination that the communication channel condition for the first wireless communication channel satisfies the communication channel condition threshold, tune to the second wireless communication channel associated with the second carrier frequency to receive the radio frequency signal transmitted by the second wireless audio transmitter.

Clause 32. The system of any one of clauses 1-31, wherein the radio frequency signal transmitted via the first wireless communication channel and the second wireless communication channel comprises a corresponding audio payload.

Clause 33. The system of clause 32, wherein the radio frequency signal comprises encoded information within a sideband portion of the radio frequency signal that corresponds to the audio payload.

Clause 34. The system of any one of clauses 32-33, wherein the radio frequency signal transmitted via the first wireless communication channel and the second wireless communication channel comprises control information based on the respective first and second wireless communication channel.

Clause 35. The system of any one of clauses 1-34, wherein the communication channel condition for the first wireless communication channel is a first communication channel condition, and wherein the determination that the communication channel condition satisfies the communication channel condition threshold is determined relative to a second communication channel condition for the second wireless communication channel.

Clause 36. The system of any one of clauses 1-35, wherein the determination is a first determination and the communication channel condition for the first wireless communication channel is a first communication channel condition, and wherein the wireless audio receiver is further configured to: compare a second communication channel condition for the second wireless communication channel to the communication channel condition threshold.

Clause 37. The system of clause 36, wherein the wireless audio receiver is further configured to: tune to the second wireless communication channel associated with the second carrier frequency based on a second determination that the second communication channel condition does not satisfy the communication channel condition threshold.

Clause 38. The system of any one of clauses 1-35, wherein the determination is a first determination and the communication channel condition for the first wireless communication channel is a first communication channel condition, and wherein the wireless audio receiver is further configured to: compare a second communication channel condition for the second wireless communication channel to a communication channel improvement threshold that is different than the communication channel condition threshold.

Clause 39. The system of clause 38, wherein the wireless audio receiver is further configured to: tune to the second wireless communication channel associated with the second carrier frequency based on a second determination that the second communication channel condition satisfies the communication channel improvement threshold.

Clause 40. The system of any one of clauses 1-39, wherein the system performs a computer-implemented method related to any one of clauses 1-39.

Clause 41. The system of any one of clauses 1-39, wherein a computer program product, stored on a computer readable medium, comprising instructions that, when executed by one or more processors of the system, cause the one or more processors to perform one or more operations related to any one of clauses 1-39.

Clause 42. A wireless audio receiver apparatus configured to improve received audio quality communicated to an in-ear monitor device, the wireless audio receiver apparatus comprising one or more processors and a memory storing instructions that are operable, when executed by the one or more processors, to cause the wireless audio receiver apparatus to: receive a radio frequency signal transmitted by a wireless audio transmitter via a first wireless communication channel associated with a first carrier frequency and a second wireless communication channel associated with a second carrier frequency different from the first carrier frequency.

Clause 43. The wireless audio receiver apparatus of clause 42, wherein the instructions are further operable to cause the wireless audio receiver apparatus to: tune to the first wireless communication channel associated with the first carrier frequency to receive the radio frequency signal.

Clause 44. The wireless audio receiver apparatus of any one of clauses 42-43, wherein the instructions are further operable to cause the wireless audio receiver apparatus to: based on a determination that a communication channel condition for the first wireless communication channel satisfies a communication channel condition threshold, tune to the second wireless communication channel associated with the second carrier frequency to receive the radio frequency signal.

Clause 45. The wireless audio receiver apparatus of any one of clauses 42-44, wherein the instructions are further operable to cause the wireless audio receiver apparatus to: output an audio signal associated with the radio frequency signal to the in-ear monitor device.

Clause 46. The wireless audio receiver apparatus of any one of clauses 42-45, wherein the instructions are further operable to cause the wireless audio receiver apparatus to: based on the determination that the communication channel condition for the first wireless communication channel satisfies the communication channel condition threshold, alter tuning of an antenna configured for wide-band tuning.

Clause 47. The wireless audio receiver apparatus of any one of clauses 42-46, wherein the instructions are further operable to cause the wireless audio receiver apparatus to: tune to the second wireless communication channel based on a determination that an interference condition for the first wireless communication channel satisfies an interference condition threshold.

Clause 48. The wireless audio receiver apparatus of any one of clauses 42-47, wherein the instructions are further operable to cause the wireless audio receiver apparatus to: tune to the second wireless communication channel based on a signal degradation condition associated with the first wireless communication channel.

Clause 49. The wireless audio receiver apparatus of any one of clauses 42-48, wherein the instructions are further operable to cause the wireless audio receiver apparatus to: tune to the second wireless communication channel based on a non-interference dependent condition associated with the first wireless communication channel.

Clause 50. The wireless audio receiver apparatus of any one of clauses 42-49, wherein the instructions are further operable to cause the wireless audio receiver apparatus to: tune to the second wireless communication channel based on the communication channel condition threshold satisfying the communication channel condition threshold for a certain interval of time.

Clause 51. The wireless audio receiver apparatus of any one of clauses 42-50, wherein the instructions are further operable to cause the wireless audio receiver apparatus to: select the first wireless communication channel based on a wireless communication channel scan operation.

Clause 52. The wireless audio receiver apparatus of any one of clauses 42-51, wherein the instructions are further operable to cause the wireless audio receiver apparatus to: establish a connection with the wireless audio transmitter via the first wireless communication channel based on a wireless communication channel scan operation.

Clause 53. The wireless audio receiver apparatus of any one of clauses 42-52, wherein the instructions are further operable to cause the wireless audio receiver apparatus to: switch between a first antenna associated with the first wireless communication channel and a second antenna associated with the second wireless communication channel based on the determination that the communication channel condition for the first wireless communication channel satisfies the communication channel condition threshold.

Clause 54. The wireless audio receiver apparatus of any one of clauses 42-53, wherein the instructions are further operable to cause the wireless audio receiver apparatus to: group the wireless audio receiver apparatus with one or more other wireless audio receiver apparatuses based on a wireless audio receiving grouping operation, wherein the one or more other wireless audio receiver apparatuses independently tune to the first wireless communication channel or the second wireless communication channel to receive the radio frequency signal.

Clause 55. The wireless audio receiver apparatus of any one of clauses 42-54, wherein the wireless audio receiver apparatus performs a computer-implemented method related to any one of clauses 42-54.

Clause 56. The wireless audio receiver apparatus of any one of clauses 42-54, wherein a computer program product, stored on a computer readable medium, comprising instructions that, when executed by one or more processors of the wireless audio receiver apparatus, cause the one or more processors to perform one or more operations related to any one of clauses 42-54.

Clause 57. A wireless audio transmitter apparatus comprising one or more processors and a memory storing instructions that are operable, when executed by the one or more processors, to cause the wireless audio transmitter apparatus to: transmit a radio frequency signal via a wireless communication channel associated with a first carrier frequency.

Clause 58. The wireless audio transmitter apparatus of clause 57, wherein the instructions are further operable to cause the wireless audio transmitter apparatus to: redundantly transmit the radio frequency signal via one or more other wireless communication channels respectively associated with different carrier frequencies.

Clause 59. The wireless audio transmitter apparatus of any one of clauses 57-58, wherein the instructions are further operable to cause the wireless audio transmitter apparatus to: receive, from a wireless audio receiver apparatus, tuning update data indicating that the wireless audio receiver apparatus has tuned from the wireless communication channel to the one or more other wireless communication channels.

Clause 60. The wireless audio transmitter apparatus of any one of clauses 57-59, wherein the instructions are further operable to cause the wireless audio transmitter apparatus to: receive, from a wireless audio receiver apparatus, communication channel condition data related to tuning of the wireless audio receiver apparatus from the wireless communication channel to the one or more other wireless communication channels.

Clause 61. The wireless audio transmitter apparatus of any one of clauses 57-60, wherein the one or more other wireless communication channels comprise a plurality of wireless communication channels respectively associated with different carrier frequencies, and wherein the instructions are further operable to cause the wireless audio transmitter apparatus to: receive, from a first wireless audio receiver apparatus, first tuning update data indicating that the first wireless audio receiver apparatus has tuned from the wireless communication channel to a first channel of the plurality of wireless communication channels.

Clause 62. The wireless audio transmitter apparatus of any one of clauses 57-61, wherein the instructions are further operable to cause the wireless audio transmitter apparatus to: receive, from a second wireless audio receiver apparatus, second tuning update data indicating that the second wireless audio receiver apparatus has tuned from the wireless communication channel to a second channel of the plurality of wireless communication channels, wherein the second wireless communication channel is associated with a different carrier frequency than the first wireless communication channel.

Clause 63. The wireless audio transmitter apparatus of any one of clauses 57-62, wherein the first tuning update data comprises a first wireless communication channel identifier associated with the first wireless communication channel of the plurality of wireless communication channels, and the second tuning update data comprises a second wireless communication channel identifier associated with the second wireless communication channel of the plurality of wireless communication channels.

Clause 64. The wireless audio transmitter apparatus of any one of clauses 57-63, wherein at least one of the first tuning update data or the second tuning update data comprises communication channel condition data indicating a communication channel condition of the wireless communication channel.

Clause 65. The wireless audio transmitter apparatus of any one of clauses 57-64, wherein the wireless audio transmitter apparatus performs a computer-implemented method related to any one of clauses 57-64.

Clause 66. The wireless audio transmitter apparatus of any one of clauses 57-64, wherein a computer program product, stored on a computer readable medium, comprising instructions that, when executed by one or more processors of the wireless audio transmitter apparatus, cause the one or more processors to perform one or more operations related to any one of clauses 57-64.

Many modifications and other embodiments of the disclosures set forth herein will come to mind to one skilled in the art to which these disclosures pertain having the benefit of the teachings presented in the foregoing description and the associated drawings. Therefore, it is to be understood that the disclosures are not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

That which is claimed is:

1. A system configured to improve received audio quality communicated to an in-ear monitor device, the system comprising:
a wireless audio transmitter configured to transmit a radio frequency signal via a first wireless communication channel associated with a first carrier frequency and a second wireless communication channel associated with a second carrier frequency different from the first carrier frequency; and
a wireless audio receiver communicatively coupled to the in-ear monitor device and configured to:
receive the radio frequency signal transmitted by the wireless audio transmitter;
tune to the first wireless communication channel associated with the first carrier frequency to receive the radio frequency signal; and
based on a determination that a communication channel condition for the first wireless communication channel satisfies a communication channel condition threshold, tune to the second wireless communication channel associated with the second carrier frequency to receive the radio frequency signal.

2. The system of claim 1, wherein the wireless audio transmitter is further configured to:
receive, from the wireless audio receiver, tuning update data after the wireless audio receiver has tuned to the second wireless communication channel associated with the second carrier frequency.

3. The system of claim 2, wherein the tuning update data comprises communication channel condition data related to tuning of the wireless audio receiver from the first wireless communication channel to the second wireless communication channel.

4. The system of claim 2, wherein the tuning update data comprises a wireless communication channel identifier associated with the second wireless communication channel.

5. The system of claim 1, wherein the wireless audio receiver is further configured to:
output an audio signal associated with the radio frequency signal to the in-ear monitor device.

6. The system of claim 1, wherein the wireless audio receiver is further configured to:
tune to the second wireless communication channel based on a determination that an interference condition for the first wireless communication channel satisfies an interference condition threshold.

7. The system of claim 1, wherein the wireless audio receiver is further configured to:
tune to the second wireless communication channel based on a signal degradation condition associated with the first wireless communication channel.

8. The system of claim 1, wherein the wireless audio receiver is further configured to:
tune to the second wireless communication channel based on a non-interference dependent condition associated with the first wireless communication channel.

9. The system of claim 1, wherein the wireless audio receiver is further configured to:
tune to the second wireless communication channel based on the communication channel condition threshold satisfying the communication channel condition threshold for a certain interval of time.

10. The system of claim 1, wherein the wireless audio receiver is further configured to:
select the first wireless communication channel based on a wireless communication channel scan operation.

11. The system of claim 1, wherein the wireless audio receiver is further configured to:
group the wireless audio receiver with one or more other wireless audio receivers based on a wireless audio receiving grouping operation, wherein the one or more other wireless audio receivers independently tune to the first wireless communication channel or the second wireless communication channel to receive the radio frequency signal.

12. The system of claim 1, wherein the wireless audio receiver is a first wireless audio receiver, and wherein the system further comprises:
a second wireless audio receiver configured to:
receive the radio frequency signal transmitted by the wireless audio transmitter; and
tune to the first wireless communication channel associated with the first carrier frequency to receive the radio frequency signal.

13. The system of claim 12, wherein the second wireless audio receiver is further configured to:
based on a second determination that a second communication channel condition for the first wireless communication channel satisfies a second communication channel condition threshold, tune to the second wireless communication channel associated with the second carrier frequency to receive the radio frequency signal.

14. The system of claim 1, wherein the wireless audio transmitter comprises:
a first wireless audio transmitter configured to transmit the radio frequency signal via the first wireless communication channel associated with the first carrier frequency; and
a second wireless audio transmitter configured to transmit the radio frequency signal via the second wireless communication channel associated with the second carrier frequency different from the first carrier frequency, and wherein the wireless audio receiver is configured to:
based on the determination that the communication channel condition for the first wireless communication channel satisfies the communication channel condition threshold, tune to the second wireless communication channel associated with the second carrier frequency to receive the radio frequency signal transmitted by the second wireless audio transmitter.

15. The system of claim 1, wherein the radio frequency signal transmitted via the first wireless communication channel and the second wireless communication channel comprises a corresponding audio payload.

16. The system of claim 15, wherein the radio frequency signal comprises encoded information within a sideband portion of the radio frequency signal that corresponds to the audio payload.

17. The system of claim 15, wherein the radio frequency signal transmitted via the first wireless communication channel and the second wireless communication channel comprises control information based on the respective first and second wireless communication channel.

18. The system of claim 1, wherein the communication channel condition for the first wireless communication channel is a first communication channel condition, and wherein the determination that the communication channel condition satisfies the communication channel condition threshold is determined relative to a second communication channel condition for the second wireless communication channel.

19. The system of claim 1, wherein the determination is a first determination and the communication channel condition for the first wireless communication channel is a first communication channel condition, and wherein the wireless audio receiver is further configured to:
compare a second communication channel condition for the second wireless communication channel to the communication channel condition threshold; and
tune to the second wireless communication channel associated with the second carrier frequency based on a second determination that the second communication channel condition does not satisfy the communication channel condition threshold.

20. The system of claim 1, wherein the determination is a first determination and the communication channel condition for the first wireless communication channel is a first communication channel condition, and wherein the wireless audio receiver is further configured to:
compare a second communication channel condition for the second wireless communication channel to a communication channel improvement threshold that is different than the communication channel condition threshold; and
tune to the second wireless communication channel associated with the second carrier frequency based on a second determination that the second communication channel condition satisfies the communication channel improvement threshold.

21. A wireless audio receiver apparatus configured to improve received audio quality communicated to an in-ear monitor device, the wireless audio receiver apparatus comprising one or more processors and a memory storing instructions that are operable, when executed by the one or more processors, to cause the wireless audio receiver apparatus to:
receive a radio frequency signal transmitted by a wireless audio transmitter via a first wireless communication channel associated with a first carrier frequency and a second wireless communication channel associated with a second carrier frequency different from the first carrier frequency;
tune to the first wireless communication channel associated with the first carrier frequency to receive the radio frequency signal; and
based on a determination that a communication channel condition for the first wireless communication channel satisfies a communication channel condition threshold, tune to the second wireless communication channel associated with the second carrier frequency to receive the radio frequency signal.

22. The wireless audio receiver apparatus of claim 21, wherein the instructions are further operable, when executed by the one or more processors, to cause the wireless audio receiver apparatus to:
output an audio signal associated with the radio frequency signal to the in-ear monitor device.

23. The wireless audio receiver apparatus of claim 21, wherein the instructions are further operable, when executed by the one or more processors, to cause the wireless audio receiver apparatus to:
based on the determination that the communication channel condition for the first wireless communication channel satisfies the communication channel condition threshold, alter tuning of an antenna configured for wide-band tuning.

24. The wireless audio receiver apparatus of claim 21, wherein the instructions are further operable, when executed by the one or more processors, to cause the wireless audio receiver apparatus to:
tune to the second wireless communication channel based on a determination that an interference condition for the first wireless communication channel satisfies an interference condition threshold.

25. The wireless audio receiver apparatus of claim 21, wherein the instructions are further operable, when executed by the one or more processors, to cause the wireless audio receiver apparatus to:
tune to the second wireless communication channel based on a signal degradation condition associated with the first wireless communication channel.

26. The wireless audio receiver apparatus of claim 21, wherein the instructions are further operable, when executed by the one or more processors, to cause the wireless audio receiver apparatus to:
tune to the second wireless communication channel based on a non-interference dependent condition associated with the first wireless communication channel.

27. The wireless audio receiver apparatus of claim 21, wherein the instructions are further operable, when executed by the one or more processors, to cause the wireless audio receiver apparatus to:
tune to the second wireless communication channel based on the communication channel condition threshold satisfying the communication channel condition threshold for a certain interval of time.

28. The wireless audio receiver apparatus of claim 21, wherein the instructions are further operable, when executed by the one or more processors, to cause the wireless audio receiver apparatus to:
select the first wireless communication channel based on a wireless communication channel scan operation.

29. The wireless audio receiver apparatus of claim 21, wherein the instructions are further operable, when executed by the one or more processors, to cause the wireless audio receiver apparatus to:
establish a connection with the wireless audio transmitter via the first wireless communication channel based on a wireless communication channel scan operation.

30. The wireless audio receiver apparatus of claim 21, wherein the instructions are further operable, when executed by the one or more processors, to cause the wireless audio receiver apparatus to:
group the wireless audio receiver apparatus with one or more other wireless audio receiver apparatuses based on a wireless audio receiving grouping operation, wherein the one or more other wireless audio receiver apparatuses independently tune to the first wireless communication channel or the second wireless communication channel to receive the radio frequency signal.

31. A wireless audio transmitter apparatus comprising one or more processors and a memory storing instructions that are operable, when executed by the one or more processors, to cause the wireless audio transmitter apparatus to:
transmit a radio frequency signal via a wireless communication channel associated with a first carrier frequency; and
redundantly transmit the radio frequency signal via one or more other wireless communication channels respectively associated with different carrier frequencies.

32. The wireless audio transmitter apparatus of claim 31, wherein the instructions are further operable, when executed by the one or more processors, to cause the wireless audio transmitter apparatus to:
receive, from a wireless audio receiver apparatus, tuning update data indicating that the wireless audio receiver apparatus has tuned from the wireless communication channel to the one or more other wireless communication channels.

33. The wireless audio transmitter apparatus of claim 31, wherein the instructions are further operable, when executed by the one or more processors, to cause the wireless audio transmitter apparatus to:
receive, from a wireless audio receiver apparatus, communication channel condition data related to tuning of the wireless audio receiver apparatus from the wireless communication channel to the one or more other wireless communication channels.

34. The wireless audio transmitter apparatus of claim 31, wherein the one or more other wireless communication channels comprise a plurality of wireless communication channels respectively associated with different carrier frequencies, and wherein the instructions are further operable, when executed by the one or more processors, to cause the wireless audio transmitter apparatus to:
receive, from a first wireless audio receiver apparatus, first tuning update data indicating that the first wireless audio receiver apparatus has tuned from the wireless communication channel to a first channel of the plurality of wireless communication channels; and
receive, from a second wireless audio receiver apparatus, second tuning update data indicating that the second wireless audio receiver apparatus has tuned from the wireless communication channel to a second channel of the plurality of wireless communication channels, wherein the second wireless communication channel is associated with a different carrier frequency than the first wireless communication channel.

35. The wireless audio transmitter apparatus of claim 31, wherein the first tuning update data comprises a first wireless communication channel identifier associated with the first wireless communication channel of the plurality of wireless communication channels, and the second tuning update data comprises a second wireless communication channel identifier associated with the second wireless communication channel of the plurality of wireless communication channels.

36. The wireless audio transmitter apparatus of claim 31, wherein at least one of the first tuning update data or the second tuning update data comprises communication channel condition data indicating a communication channel condition of the wireless communication channel.
